(19) United States
(12) Patent Application Publication
(10) Pub. No.: US 2025/0356636 A1
(43) Pub. Date: Nov. 20, 2025

(54) SYSTEMS AND METHODS FOR LABELING IMAGES FOR TRAINING MACHINE LEARNING MODEL

(71) Applicant: Tesla, Inc., Austin, TX (US)

(72) Inventors: Andrej Karpathy, Austin, TX (US); Ashok Elluswamy, Austin, TX (US); I-te Danny Hung, Austin, TX (US); Kate Park, Austin, TX (US); Dong Yan, Austin, TX (US); Tushar Agrawal, Austin, TX (US)

(73) Assignee: Tesla, Inc., Austin, TX (US)

(21) Appl. No.: 18/867,357

(22) PCT Filed: May 18, 2023
(86) PCT No.: PCT/US2023/067185

§ 371 Date: Nov. 19, 2024

Related U.S. Application Data
(60) Provisional application No. 63/344,303, filed on May 20, 2022.

(51) Int. Cl. G06V 10/774; G06V 10/26; G06V 10/776; G06V 10/94; G06V 20/58; G06V 20/70

(52) U.S. Cl. CPC G06V 10/774; G06V 10/26; G06V 10/776; G06V 10/945; G06V 20/584; G06V 20/70

(57) ABSTRACT

This application relates to systems and methods to train a machine learning model used for autonomous driving. The system includes a plurality of vehicles configured to capture at least the front surrounding view of the vehicle, a machine learning training system, and a verification computing device. The machine learning training system is configured to receive the captured images from the vehicles. The verification computing device is configured to verify whether the machine learning model correctly identified the light indicator of vehicles shown in the captured image. The verification device may determine a disagreement between the vehicle's predicted light indicator and the correct light indicator. In determining that at least one vehicle has a disagreement, the verification computing device is configured to modify the light indicator label and correct label. Then, the modified label can be fed into the machine learning model and used for training the machine learning model.

### CROSS-REFERENCE TO RELATED APPLICATION

This application claims priority to U.S. Provisional Patent Application No. 63/344,303 entitled “SYSTEMS AND METHODS FOR LABELING IMAGES FOR TRAINING A MACHINE LEARNING MODEL” and filed on May 20, 2022, the disclosure of which is hereby incorporated herein by reference in its entirety.

### BACKGROUND

### Technical Field

Embodiments of the present disclosure relate to systems and methods for labeling images for training a machine learning model. More specifically, embodiments of the present disclosure relate to systems and methods for training a machine learning model to detect light indicators on one or more vehicles as part of an autonomous driving system.

### Description of Related Technology

Autonomous driving systems (e.g., self-driving systems) typically obtain images of the roadway and proximate vehicles and input those images into a trained machine learning model to control the vehicle without, or with limited, user input. The machine learning model used in such systems is generally trained by first capturing millions or billions of images and then labeling those images with feature labels indicating the features which are to be identified in the vehicle's surrounding environment. For example, the features may include curbs, painted lines, other vehicles, cones, traffic signals and other items found on roadways. Once the machine learning model is trained to recognize these features, the machine learning model can be downloaded and stored in a memory of the vehicle so that the vehicle can be run in an autonomous or semi-autonomous mode.

### SUMMARY

The innovations described in the claims each have several aspects, no single one of which is solely responsible for its desirable attributes. Without limiting the scope of the claims, some prominent features of this disclosure will now be briefly described.

One aspect of this disclosure includes a system for labeling images for training a machine learning model to detect light indicators on a vehicle. The system includes obtaining images of one or more vehicles on a roadway, identifying a position of each of the one or more vehicles, displaying a graphical indicia on each of the one or more vehicles to indicate that the vehicle was detected by the system, and receiving an indication of whether a light indicator is active or inactive on each of the one or more vehicles to label the image for a machine learning model.

In the system, obtaining images can include obtaining images from a plurality of vehicles having autonomous driving systems, and obtaining images can further include obtaining images of the plurality of vehicles when the autonomous driving system determines that a light indicator detection was improperly determined by the autonomous driving system.

In the system, identifying the position of each of the one or more vehicles can include identifying vehicles in the images and determining graphical coordinates of the vehicles in the images.

In the system, displaying the graphical indicia on each of the one or more vehicles can include displaying a bounding box around each of the one or more vehicles in the obtained images.

In the system, identifying the position of each of the one or more vehicles can include performing image segmentation on the obtained images, and the image segmentation generates regions of each obtained images can correspond to the vehicles.

In the system, receiving an indication of whether a light indicator is active or inactive can include receiving a mouse selection from a user which labels the vehicle as having an active or inactive light indicator.

In the system, receiving the indication of whether a light indicator is active or inactive can include receiving an indication of whether a brake light is active or inactive.

In the system, receiving the indication of whether a light indicator is active or inactive can include receiving an indication of whether a turn signal is active or inactive.

Another aspect of the present disclosure includes a system for labeling images for training a machine learning model to detect light indicators on a vehicle. The system includes obtaining images of one or more vehicles on a roadway, identifying a position of each of the one or more vehicles in the obtained images, determining whether a light indicator was indicated as active or inactive by an autonomous driving system in each of the one or more vehicles, determining, from the images of one or more vehicles, one or more vehicles having a false prediction of whether the light indicator was active or inactive, and labeling the images having a false prediction with a correct indication of whether the light indicator is active or inactive.

In the system, identifying the position of each of the one or more vehicles can include identifying vehicles in the images and determining graphical coordinates of the vehicles in the images.

In the system, obtaining images can include obtaining images from a plurality of vehicles having autonomous driving systems. Obtaining images can further include obtaining images from the plurality of vehicles when the autonomous driving system determines that the light indicator detection was improperly determined by the autonomous driving system

In the system, displaying a graphical indicia on each of the one or more vehicles to indicate that the vehicle can be detected by the system. Displaying the graphical indicia on each of the one or more vehicles can also include displaying a bounding box around each of the one or more vehicles in the obtained images.

In the system, the indication of whether the light indicator is active or inactive of each of the one or more vehicles can be predicted by an autonomous driving system of each of the vehicles.

In the system, the false predictions can represent a disagreement between the light indicator and the position of the vehicle.

The system can further include receiving a updated light indicator receiving a mouse selection from a user which labels the vehicle with the light indicator based on the position of the vehicle.

In the system, the indication of whether a light indicator is active or inactive can be an indication of whether a brake light is active or inactive.

In the system, the indication of whether a light indicator is active or inactive can be an indication of whether a turn signal is active or inactive.

Another aspect of the present disclosure includes a method for labeling images for training a machine learning model to detect light indicators on a vehicle. The method includes obtaining images of one or more vehicles on a roadway, identifying a position of each of the one or more vehicles, labeling an indication of whether a light indicator is active or inactive on each of the one or more vehicles, determining, from the images of one or more vehicles, one or more vehicles having a false prediction, and receiving an updated indication of whether the light indicator is active or inactive on the vehicles having the false prediction.

In the method, identifying the position of each of the one or more vehicles can include identifying vehicles in the images and determining graphical coordinates of the vehicles in the images.

In the method, obtaining images can include obtaining images from a plurality of vehicles having autonomous driving systems.

In the method, obtaining images can include obtaining images from the one or more vehicles when the light indicator detection was improperly determined by an autonomous driving system of each vehicle.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of this disclosure will be described, by way of non-limiting examples, with reference to the accompanying drawings.

FIG. 1 is a block diagram illustrating communication between a plurality of vehicles, a network server, and a verification computing device.

FIG. 2 is a schematic diagram illustrating an example of a vehicle.

FIG. 3A is a block diagram which depicts one embodiment of an architecture of the vehicle autonomous driving system in FIG. 2.

FIG. 3B is a block diagram which depicts one embodiment of an architecture of the machine learning training system in FIG. 1.

FIG. 4 illustrates an example of a vehicle having cameras for capturing images of other vehicles.

FIG. 5 illustrates an example of a captured image, including an identified light indicator associated with each vehicle in the image.

FIG. 6A illustrates an example of the identified light indicator verification of vehicles in the captured image.

FIG. 6B illustrates an example of an interactive graphical user interface to label the graphical indicia of vehicles in the captured image.

FIG. 7 illustrates an example of labeling the graphical indicia with a correct light indicator of the vehicles in the captured image.

FIG. 8 is a flowchart illustrating one embodiment of an example process that the verification computing device may perform to detect one or more vehicles in a captured image having a disagreement between the identified light indicator and an actual light indicator of the vehicle.

FIG. 9 is a flowchart illustrating one embodiment of an example process that the verification computing device may perform to train the machine learning model.

FIGS. 10A-10D illustrates examples of light indicator detection in various environments.

FIG. 11 illustrates an example interactive user interface which may be used by a user.

### DETAILED DESCRIPTION

Although certain preferred embodiments and examples are disclosed below, the inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations, in turn, in a manner that may be helpful in understanding certain embodiments; however, the order of description should not be construed to imply that these operations are order-dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

One or more aspects of the present application correspond to systems and methods for training a machine learning model associated with autonomous driving systems. An example machine learning model can be used to detect nearby vehicles and determine whether the nearby vehicles have a detectable light indicator or signal. In some embodiments, the light signal may be a brake light, a turn indicator, a headlight, or any other illuminated indicator on the vehicle. The light signal may also be a brake light, turn indicator, and so on, associated with a trailer connected to the vehicle. In some embodiments, the detectable light indicator may be on a roadway, such as a traffic signal, flashing stop signal, or other illuminated signal that is on typical roadways. Based on the determined light indicator, the autonomous driving system can predict the nearby detected vehicles' driving path, speed, etc.

Embodiments of the disclosed technology correspond to systems and methods for training a machine learning model by more accurately labeling light indicators in captured images from vehicles or roadway features (e.g., images obtained from image sensors of cameras positioned on the vehicles). More specifically, the systems and methods are used to obtain images captured by cameras mounted on vehicles as the vehicles drive on the roadway. Those captured images may then be uploaded to a server or outside system so that the images can be labeled with various features. The uploaded images may be displayed to a user (e.g., human user, software agent) so that the user can identify and label the state of light indicators found within the captured image for use as training data. For example, a captured image may be of a vehicle with an illuminated left turn signal. The user may select, via a user interface, that the left turn signal is illuminated and then store that label with the figure for use in training an autonomous or semi-autonomous machine learning model such as a vision model. As another example, the image may be of a traffic signal, and the user may label the figure as showing that the traffic had a red light illuminated. The terms, images and video clip, are used interchangeably throughout the present disclosure, and these terms have a similar meaning. For example, if the set of sequentially captured images is 300, 10 seconds of video clips at a rate of 30 fps can be played. Thus, the 300 captured images can have a same meaning as 10 seconds of a video clip. The number of images and the video clip rate are provided merely as an example, and various numbers of images and rates can be used based on a specific application.

In some embodiments, the labeling system used by the user to label the images may include certain elements to increase the accuracy of the labeling. For example, the system may automatically outline each vehicle in the image with a graphic, such as a bounding box, so that the user can select a particular vehicle to be labeled. The user may select a bounding box around a vehicle (e.g. via an interactive user interface) and then be presented with a variety of options for labeling the light indicators on that vehicle. The options may include a left turn signal, a right turn signal, brake lights, or similar features of the vehicle. This allows the user to label a plurality of vehicles in a single captured image with different features to increase the accuracy of the labeling process and improve the ability of the images to train a machine learning model to identify light indicators of vehicles on a roadway.

In some embodiments, the vehicle which is capturing and uploading images may be only uploading those images where an error in a light indicator prediction was discovered. For example, the vehicle may be running autonomous driving software and identify in a captured image that the vehicle in front has no brake lights illuminated. But the vehicle may also detect that the front vehicle is slowing down due to traffic. In that circumstance, the brake light should likely have been illuminated, so the captured image which was identified as having no brake light illuminated may be uploaded to a server for manual labeling of the brake lights to improve future models for autonomous driving.

In some embodiments, the vehicle which is uploading images may be running autonomous software in a stealth mode, where the vehicle is not driving in an autonomous mode, but the vehicle is nonetheless still capturing images and determining actions for the vehicle as if the system was controlling the vehicle. In this stealth mode, the vehicle may identify potential errors in how it's handling light indicators and upload the images which led to the potential errors to a server for handling, review and updated labeling by a user.

To resolve errors in an autonomous driving system related to the light indicator determination, the machine learning model can be trained by updating the machine model with correct data by the methods described herein. Illustratively, the incorrect light indicator data (e.g., image or video clips) that is based on the machine learning model can be corrected by receiving the correct light indicator data. For example, the correct light indicator data can be overlayed on the incorrect light indicator data, and the overlayed data can be used to train the machine learning model. The train can include updating or modifying a plurality of parameters and attributes related to the machine learning model.

Various aspects of the machine learning model training will now be described with regard to certain examples and embodiments, which are only intended to illustrate. Although the examples and embodiments described herein will focus, for the purpose of illustration, on specific calculations and algorithms, one of skill in the art will appreciate the examples are illustrated only and are not intended to be limiting.

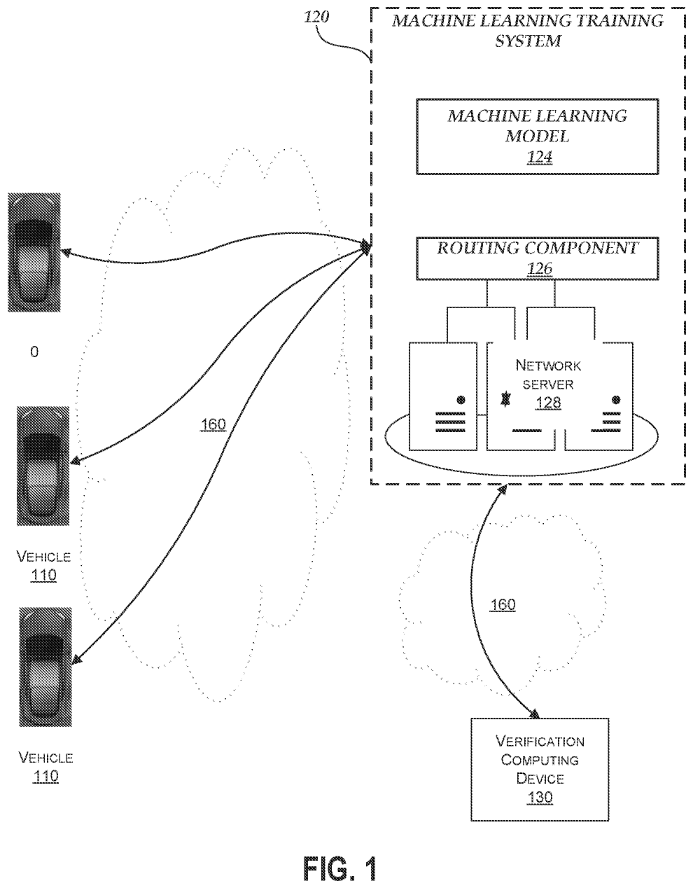

FIG. 1 is a block diagram illustrating an embodiment of a system 100. The system 100 can comprise a network, the network connecting a number of vehicles 110, a machine learning training system 120, and a verification computing device 130. Illustratively, the various aspects associated with the machine learning training system 120 can be implemented as one or more components that are associated with one or more functions or services. The components may correspond to software modules implemented or executed by one or more external computing devices, which may be separate stand-alone external computing devices. Accordingly, the components of the machine learning training system 120 should be considered as a logical representation of the service, not requiring any specific implementation on one or more external computing devices.

Network 160, as depicted in FIG. 1, connects the vehicles 110 and the verification computing device 130 to the machine learning training system 120. The network 160 can comprise any combination of wired and/or wireless networks, such as one or more direct communication channels, local area network, wide area network, personal area network, and/or the Internet, for example. In some embodiments, the network 160 may include one or more wireless networks, such as a Global System for Mobile Communications (GSM) network, a Code Division Multiple Access (CDMA) network, a Long Term Evolution (LTE) network, 5G communications, or any other type of wireless network. Network 160 can use protocols and components for communicating via the Internet or any of the other aforementioned types of networks. For example, the protocols used by the network 160 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein. In some embodiments, wireless communication via the network 160 may be performed on one or more secured networks, such as communicating with an encrypting data via SSL (e.g., 256-bit, military-grade encryption). The various communication protocols discussed herein are merely examples, and the present application is not limited thereto.

The vehicles 110 in FIG. 1 can connect to the machine learning training system 120. The vehicles 110 can be a set of a plurality of vehicles. In some embodiments, each of the vehicles 110 is configured to capture its surrounding images, including nearby vehicles, traffic signals, the surrounding environment, etc. The captured images can be encoded as video files based on the resolution specification of each of the cameras and transmitted (e.g., uploaded) to the machine learning training system 120 via the network 160. In some embodiments, each vehicle 110 may include one or more microprocessors and circuitry configured to establish a wireless communication channel to connect the network 160. To establish a wireless communication channel, each of the vehicles 110 may periodically (or continuously) scan and detect any nearby wireless signal. In another embodiment, an operator of the vehicle 110 can manually establish the wireless connection and connect to the network 160. For example, the operator can access a nearby Wi-Fi router, so the vehicle 110 is wirelessly connected with the network 160.

The machine learning training system 120 in FIG. 1 can train a machine learning model 124 and may provide the model to the vehicles 110 for use in autonomous or semi-autonomous driving. Illustratively, the machine learning training system 120 can include the machine learning model 124, a routing component 126, and a network server 128. The network server 128 is configured to store the received captured images from the vehicles 110.

The machine learning model 124, as shown in FIG. 1, can be a part of a machine learning training system 120. In some embodiments, the machine learning model 124 is included in the machine learning training system 120. In other embodiments, the machine learning model 124 is a stand-alone component and interconnected with other components in the machine learning training system, such as the network server 128.

In some embodiments, the machine learning model 124 is configured to identify features in the captured images stored in the network server 128. For example, the features may include curbs, painted lines, other vehicles, cones, traffic signals, and other items found on roadways. Thus the machine learning model 124 may be, or include, a vision-only model such as a convolutional neural network, a transformer network, a fully-connected network, a combination thereof, and so on.

Among the features, the machine learning model 124 may be configured to identify the light indicator of surrounding vehicles positioned in front of the vehicle 110 (or surrounding vehicles captured by the front cameras of the vehicle 110). The identified light indicator can be displayed on the vehicles included in the images.

In the example of FIG. 1, the verification computing device 130 is connected with the machine learning training system 120 via the network 160. In some embodiments, one or more authorized analysts, including a manager, developer, supervisor, administrator, etc., can access the network server 128 using the verification computing device 130. The verification computing device 130 can be any computing device such as a desktop, laptop, personal computer, tablet computer, wearable computer, server, personal digital assistant (PDA), hybrid PDA/mobile phone, mobile phone, smartphone, set-top box, voice command device, digital media player, and the like. The verification computing device 130 may execute an application (e.g., a browser, a stand-alone application, etc.) that allows users to access interactive user interfaces, view images, analyses, aggregated data, and/or the like described herein. In addition, the verification computing device 130 may have a display and input devices through which a user can interact with the user-interface component.

The verification computing device 130 can be configured to access the network server 128 via the network 160 and download one or more images or video clips stored in the network server 128. In some embodiments, the verification component device 130 is configured to identify (or predict) light indicators of vehicles in the downloaded images or video clips. In identifying the light indicator of the vehicles, the verification component device 130 can be configured to use one or more attributes or algorithms stored in the machine learning model 124. For example, an analyst may download the captured images from the network servers 128 and execute an instruction to the machine learning model to identify light indicators on the vehicles included in the downloaded images.

In some embodiments, the verification computing device 130 is configured to determine whether the machine learning model correctly identified features in the captured images. In these embodiments, the analyst, using the verification computing device 130, may determine whether the machine learning model 124 correctly identified the light indicator of the surrounding vehicles in captured images. For example, the analyst may analyze the images or video clips to determine whether there is a disagreement between the identified light indicator of vehicles in the captured image and an actual light indicator and the driving path of the vehicles.

In some embodiments, the verification computing device 130, after determining that the light indicator of one or more vehicles in the image is incorrectly determined, may be configured to flag those images. The analyst may correct the flagged images. In some embodiments, the corrected images can be uploaded into the network server 128. In some embodiments, the analyst may use the corrected images as training data to train the machine learning model 124. For example, the training data can be fed into the machine learning model 124. In this example, the machine learning model may update or modify its algorithm or attribute related to the trained machine learning model. The trained machine learning model can be provided to the vehicles 110 via the routing component 126. The vehicles 110 can thus execute the model, such as via computing forward passes based on input of images.

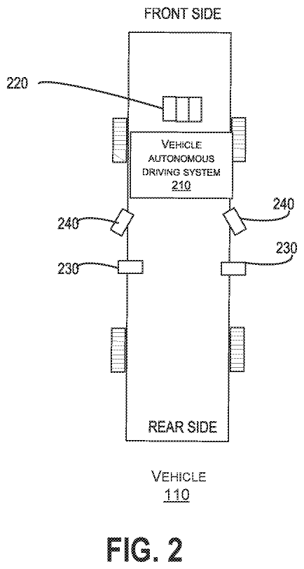

FIG. 2 is a schematic diagram illustrating an example of a vehicle 110. FIG. 2 shows a top view of the vehicle 110, illustrating the placement of multiple image sensors or cameras 220, 230, 240 (e.g., cameras configured for mounting at either internal or external vehicle locations). In some embodiments, the vehicle 110 is configured to capture the surrounding images. In some embodiments, the vehicle 110 has an autonomous driving functionality (e.g., self-driving). In some embodiments, the cameras are positioned in various locations within and outside of the vehicle 110. Illustratively, in FIG. 2, front cameras 220 are mounted on the front side of the vehicle 110, such as on the upper side of a front windshield. Pillar cameras 230 are mounted on both sides of the vehicle 110, such as the pillars of the vehicle 110. For example, the pillar cameras 230 can be mounted inside the pillars. Repeater cameras 240 are mounted on both repeater sides of the vehicle 110.

In some embodiments, the cameras 220, 230, 240 capture images of the roadway and vehicles surrounding the vehicle 110. In these embodiments, the front cameras 220 capture front images of the vehicle 110. The pillar cameras 230 are configured to capture images of both sides of the vehicle 110. The repeater cameras 240 are configured to capture behind images of the vehicle 110.

In some embodiments, the vehicle 110 includes at least one controller having one or more microprocessors and circuitry configured to establish a wireless communication channel connected with the network 160. The controller may transmit (e.g., feed or upload) the captured images to the network server 128 via the network 160. The captured images also can be encoded as video files based on the resolution specification of each of the cameras and transmitted to the network server 128.

In some embodiments, the vehicle 110 includes a vehicle autonomous driving system 210. The vehicle autonomous driving system 210 may control the vehicle 110 for autonomous driving (e.g., self-driving). The autonomous driving system 210 may access the captured images and identify surrounding features based on a machine learning model provided by the machine learning training system 120. For example, the features may include a light indicator of each surrounding vehicle that is displayed on images captured by the front cameras 220. The features may also include road information such as curbs, painted lines, cones, traffic signals and other items found on roadways. The communication configuration between the cameras 220, 230, 240, and the autonomous driving system 210 can be either direct or indirect communication via a wired connection using communication cables or a bus. Various wired communication networks, such as a controller area network (CAN), can be used, and network protocol can be specified based on a specific application.

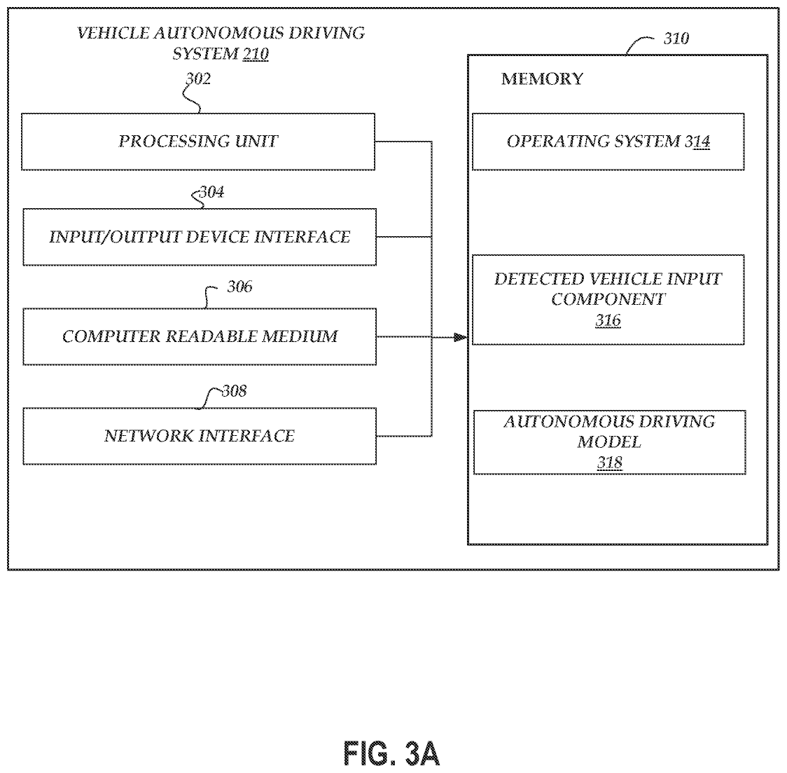

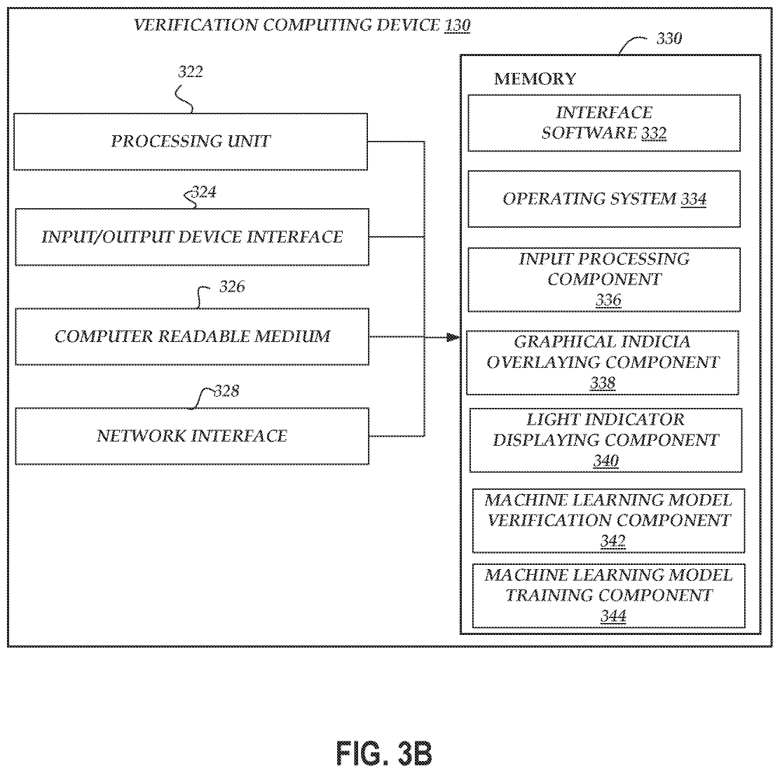

FIG. 3A is a block diagram that depicts one embodiment of an architecture of the autonomous driving system 210. The general architecture of the autonomous driving system 210 includes an arrangement of computer hardware and software components that may be used to implement embodiments of the present disclosure. As illustrated, the autonomous driving system 210 includes a processing unit 302, an input/output device interface 304, a computer readable medium 306, and a network interface 308, all of which may communicate with one another by way of a communication bus. The components of the autonomous driving system 210 may be physical hardware components mounted within the vehicle 110.

The input/output device interface 304 may provide connectivity to the cameras 220, 230, 240. The input/output device interface 304 may thus receive the captured images or video files from the cameras 220, 230, 240. The received images or video files can be stored in the computer readable medium 306. The computer readable medium 306 can be an internal or an external drive and can communicate to and from the memory 310.

The memory 310 may include computer program instructions that the processing unit 302 executes in order to implement one or more embodiments. The memory 310 generally includes RAM, ROM, or other persistent or non-transitory memory. The memory 310 may store an operating system 314 that provides computer program instructions for use by the processing unit 302 in the general administration and operation of the autonomous driving system 210. The memory 310 may further include computer program instructions and other information for implementing aspects of the present disclosure. For example, the memory 310 includes a detected vehicle input component 316 that is configured to obtain the captured images or video files from the cameras 220, 230, 240. The memory 310 further includes an autonomous driving model 318 configured to provide a vehicle autonomous driving functionality by identifying the surrounding features of the vehicle 110. For example, the features may include curbs, painted lines, other vehicles, cones, traffic signals, and other items found on roadways. In some embodiments, the machine learning model 124 can be fed into the autonomous driving model 124 via the network 160, so the autonomous driving model 318 uses the attributes, parameters, and algorithms implemented in the machine learning model 124. In some embodiments, the autonomous driving model 318 can be updated with a trained machine learning model.

In some embodiments, the processing unit 302 may also communicate with memory 310 and further provide output information for autonomous vehicle driving via the input/output device interface 304. Illustratively, the process unit 302 may receive a light indication of each vehicle that is identified by the autonomous driving model 318. In response to receiving the identified light indication of the vehicles, the process unit 302 may execute one or more commands to the autonomous driving system 210 to adapt its autonomous driving based on the light indication. For example, after obtaining the detected vehicles from the detected vehicles input component 316, autonomous driving model 318, based on a plurality of machine learning attributes, determines that one of the detected vehicles turned on a right turn signal and identified the right turn signal indication. In this example, the processing unit 302 may execute a command to the autonomous system to reduce the speed of the vehicle 110 or steer the vehicle 110 in a specific direction.

The network interface 308 may provide connectivity to one or more networks or computing systems, such as the network 160 of FIG. 1. In some embodiments, the processing unit 302 executes transmitting or receiving data to or from the network server 128 via the network interface 308.

FIG. 3B depicts one embodiment of an architecture of verification computing device 130 (as shown in FIG. 1). The general architecture of the verification computing device 130 includes an arrangement of computer hardware and software components that may be used to implement embodiments of the present disclosure. As illustrated, the verification computing device 130 includes a processing unit 322, an input/output device interface 324, a computer readable medium 326, and a network interface 328, all of which may communicate with one another by way of a communication bus. One or more authorized analysts, including a manager, developer, supervisor, administrator, etc., may use the verification computing device 130 to execute an instruction related to one or more of the embodiments of the present disclosure.

The input/output device interface 324 may provide connectivity to the network server 128. Thus, the processing unit 322 may access the network server 128 to transmit or receive data via the input/output device interface 324. In some embodiments, the data received from the network server 128 is stored in the computer readable medium 326. The computer readable medium 326 can be an internal or an external drive and can communicate with the memory 310.

The memory 330 may include computer program instructions that the processing unit 322 executes in order to implement one or more embodiments. The memory 330 generally includes RAM, ROM, or other persistent or non-transitory memory. The memory 330 may store an operating system 334 that provides computer program instructions for use by the processing unit 332 in the general administration and training of the machine learning model 124. The memory 330 may further include computer program instructions and other information for implementing aspects of the present disclosure. For example, the memory 330 includes an input processing component 336, a graphical indicia overlaying component 338, a light indicator displaying component 340, a machine learning model verification component 342, and a machine learning model training component 344.

The input processing component 336 in FIG. 3B is configured to obtain captured images of the surrounding of the vehicle 110. The input processing component 336 is configured to access the captured images of the surrounding vehicles, where the images are stored in the network server 128. The surrounding images of the vehicle 110 can be captured using cameras mounted on each of the vehicle 110 and transmitted to the network server 128. The captured images may be used for autonomous driving (e.g., self-driving) by the machine learning model 124, identifying one or more features in the vehicle's surrounding environment. For example, the features may include curbs, painted lines, other vehicles, cones, traffic signals, and other items found on roadways. In some embodiments, the captured images are used to train the machine learning model 124. For example, in response to determining that the machine learning model incorrectly identified one of the features in the images, the an analyst, using the verification computing device 130, may label the images to correct the identified feature and use the labeled image to train the machine learning model.

The graphical indicia overlaying component 338 can be configured to generate a graphical indicia for each of the vehicles in the captured images. For example, the graphical indicia may be included or presented in an interactive user interface which presents images captured by vehicles. The graphical indicia can be a box shape and overlayed on top of the vehicles in the captured images. In some embodiments, the graphical indicia represent one or more semantics associated with the vehicle. For example, the graphical indicia may represent identified light indicator of the vehicles in the captured images such as whether the light indicator of the vehicle is identified (by the machine learning model 124) or not. In another example, the graphical indicia may represent the type of light indicator identified by the machine learning model 124. The graphical indica also can be used to label one or more semantic associated with the vehicle.

For example, an analyst may label the graphical indicia associated with the vehicle with analyzed light indicator information of the vehicle. The labeling may be effectuated via user input to an interactive user interface which is presenting images or video clips obtained from vehicles. In some embodiments, the graphical indicia overlaying component 338 overlays a specific graphical representation on the graphical indicia associated with a vehicle having the disagreement. For example, if a vehicle in the captured image has a disagreement, such that the machine learning model identified the blinking brake light of a vehicle where the actual brake light was off, the graphical indicia overlaying component 338 may overly the graphical indicia on the vehicle with a specific graphical representation. The specific graphical representation can be any representation, such as based on the color or shape of the graphical indicia, adding any annotation on or near the graphical indicia, etc.

In some embodiments, the graphical representation of indicia is two-dimensional. In these embodiments, the graphical indicia overlaying component 338 may identify image pixels related to the vehicles. Then, a two-dimensional box can be generated and overlayed on the image of vehicles. In some embodiments, the graphical indicia overlaying component 338 can perform image segmentation on the captured images to identify the vehicles and any lights. For example, the graphical indicia overlaying component 338 may segment the captured image into regions (e.g., group of pixels) associated with vehicles and those regions that do not correspond to vehicles. In some embodiments, the graphical indicia overlaying component 338 generates the two-dimensional box on the regions associated with vehicles. In some embodiments, upon determining the regions associated with vehicles, the graphical indicia overlaying component 338 may generate three-dimensional volume and overlay onto the regions associated with vehicles.

The light indicator displaying component 340 in FIG. 3B can be configured to display an identified light indicator of vehicles in the captured images. An analyst may execute an instruction to the light indicator displaying component 340 to obtain a set of sequentially captured images (or video clips), where each image includes a graphical indicia. In some embodiments, the light indicator displaying component 340 can be configured to request the machine learning model to identify or predict the light indicator of vehicles included in the captured images. After the machine learning model identifies the light indicator associated with vehicles in the captured image, the light indicator displaying component 340 is configured to obtain the identified light indicator and display on the graphical indicia associated with each vehicle in the captured images.

The machine learning model verification component 342 in FIG. 3B can be configured to determine one or more captured images having at least one disagreements between the identified light indicator of vehicles in the image and the actual light indicator. Using the machine learning model verification component 342, the analyst may detect the disagreement by comparing the identified light indicator with an actual light indicator and the vehicles' driving path in the images. Some examples of potential disagreements are shown in Table 1.

TABLE I

| Machine learning model | Actual light | |
|---|---|---|
| identification of | indicator and | |
| light indicator of a | driving path of | Disagreement |
| vehicle | the vehicle | detection |
| Light indicator: active | Light indicator: inactive | Disagreement |
| (brake light on) | (brake light off) | detected |
| | Driving path: moving | (False positive |
| | forward without reducing | disagreement) |
| | speed | |
| Light indicator: | Light indicator: active | Disagreement |
| inactive (brake light off) | (brake light on) | detected |
| | Driving path: moving | (False negative |
| | forward with reducing | disagreement) |
| | speed | |
| Light indicator: | Light indicator: inactive | Disagreement |
| active (left turn | (signal light off) | detected |
| signal on) | Driving path: moving | |
| | forward without reducing | |
| | speed | |
| Light indicator: | Light indicator: active | Disagreement |
| inactive (signal | (left signal light on) | detected |
| lights off) | Driving path: changing | |
| | line to the left line | |
| Light indicator: active | Light indicator: active | Disagreement |
| (brake light on) | (emergency vehicle light) | detected |
| | Driving path: moving | |
| | forward without reducing | |
| | speed | |

The memory 330 further includes the machine learning model training component 344 which is configured to train the machine learning model. The training can be based on the disagreement corrections. In some embodiments, one or more vehicles in the captured image associated with the detected disagreements are labeled with a correct light indicator. The correct light indicator may be determined by the analyst. The analyst may label the correct light indicator information on the graphical indicia of the vehicles associated with the disagreement. After receiving the label (correct light indicator data), the machine learning model training component 348 may correct the captured images having one or more disagreements and store them in the network server 128. In some embodiments, the processing unit 322, based on the corrected images, commands the machine learning model 124 to execute an instruction to update, modify, or add one or more attributes related to the light indicator identification.

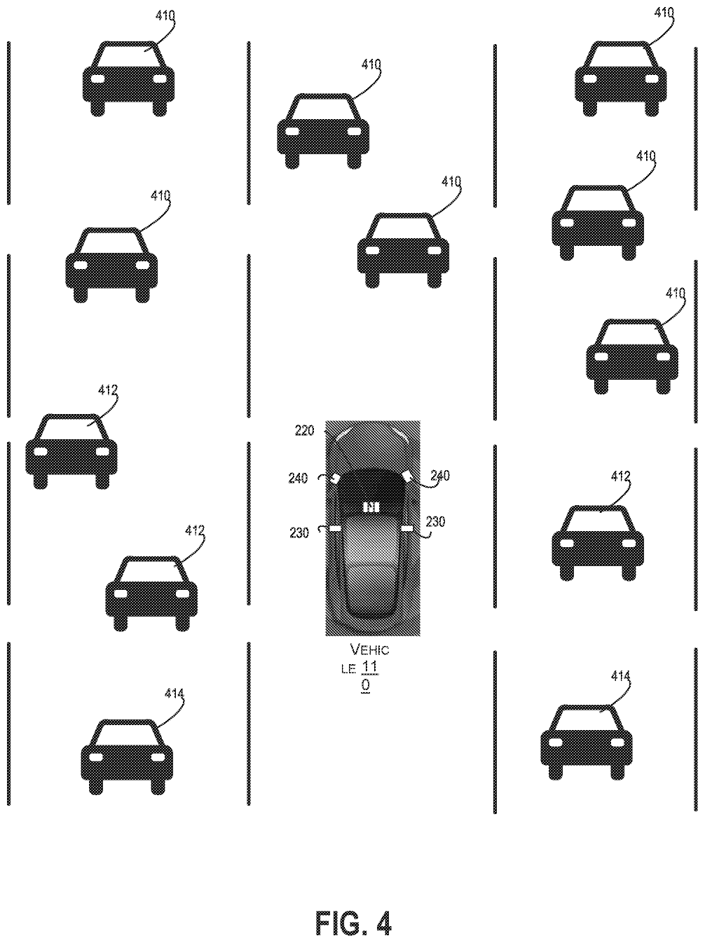

FIG. 4 illustrates an example of a vehicle having cameras for capturing images of other vehicles. For ease of illustration, FIG. 4 may be discussed with reference to certain components of FIGS. 1, 2, 3A, and 3B. For illustration purposes, FIG. 4 shows atop view including the vehicle 110 and surrounding vehicles captured by the cameras 220, 230, 240. The vehicle 110 may include the front cameras 220, pillar cameras 230, and repeater cameras 240. The front cameras 220 are configured to capture the front images positioned in front of the vehicle 110, such that the vehicle 410 can be captured in the images. The pillar cameras 230 are configured to capture the side images positioned on both sides of the vehicle 110, such that vehicles 412 can be captured in the images. The repeater cameras 240 are configured to capture the behind images positioned behind the vehicle 110, such that vehicles 414 can be captured in the images.

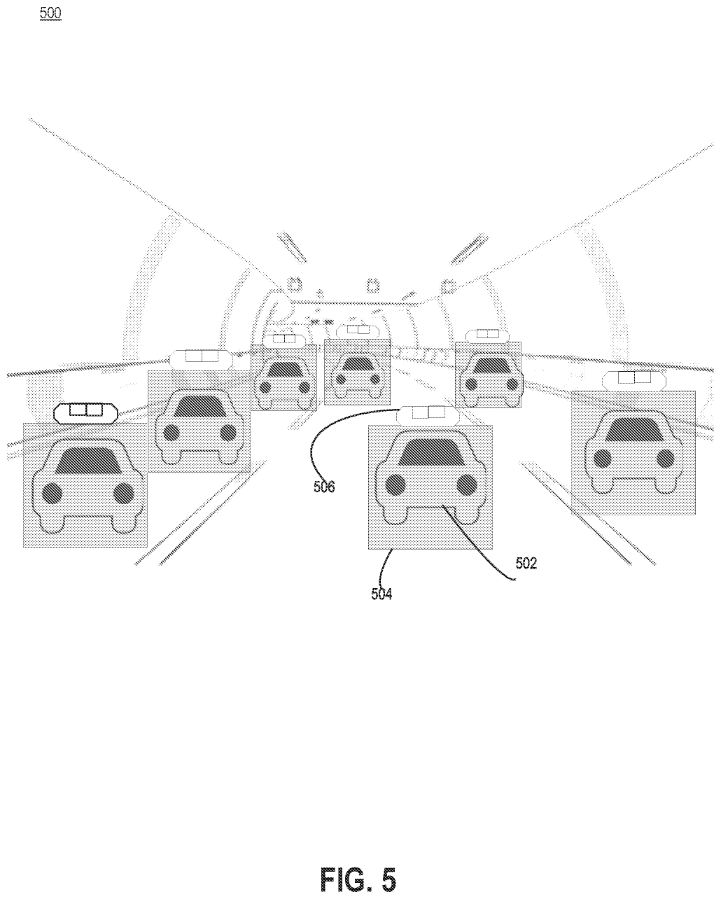

FIG. 5 illustrates an example of a captured image, including an identified light indicator associated with each vehicle in the image. The illustrated example may be included, for example, in an interactive user interface used by a user associated with labeling training data. The user may access images or video clips obtained from a fleet of vehicles executing the above-described machine learning model. Thus, the image form part of a video clip obtained by a vehicle in the fleet of vehicles. Advantageously, and to reduce a burden associated with labeling, the image may include bounding boxes indicating objects (e.g., vehicles) along with light indicators (e.g., light indicator 506). The light indicator 506 may be assigned by the machine learning model, and the user may provide user input (e.g., touch-based input, mouse/keyboard, voice input) to change the light indicator 506 (e.g., to cause the indicator to reflect turning left, brake lights, hazard lights, and so on).

For ease of illustration, the FIG. 5 may be discussed with reference to certain components of FIGS. 1, 2, 3A, and 3B. The light indicator can be identified by the machine learning model 124. As shown in FIG. 5, the image 500, including the vehicles 502, is captured by the front cameras mounted on a vehicle 110. The front cameras of the vehicle 110 may capture a front view image of the vehicle, and the vehicle 110 is configured to transmit the captured image to the network server 128. In some embodiments, a user (e.g., an analyst), using the verification computing device 130, can view or overlay a graphical indicia on each vehicle included in the captured image.

For example, as shown in FIG. 5, the graphical indicia 504 has a box shape and is overlayed on each vehicle 502. In one embodiment, the analyst, using the verification computing device 130, overlays the graphical indicia 504 on selected vehicles, such as a certain number of vehicles closer to the vehicle 110. The number of the selected vehicle can be determined based on a specific application. In some embodiments, the graphical indicia 504 may include one or more semantics related to the vehicle. In the example, as shown in FIG. 5, each graphical indicia 504 includes identified light indicator 506 associated with the vehicle. In these embodiments, the light indicator of each vehicle can be identified by the machine learning model 124. The machine learning model 124 identifies the light indicator of each vehicle based at least on its learning parameter, algorithm, or attributes related to identifying the light indicator. The light indicator, for example, may include turn signals, brake lights, emergency lights, etc.

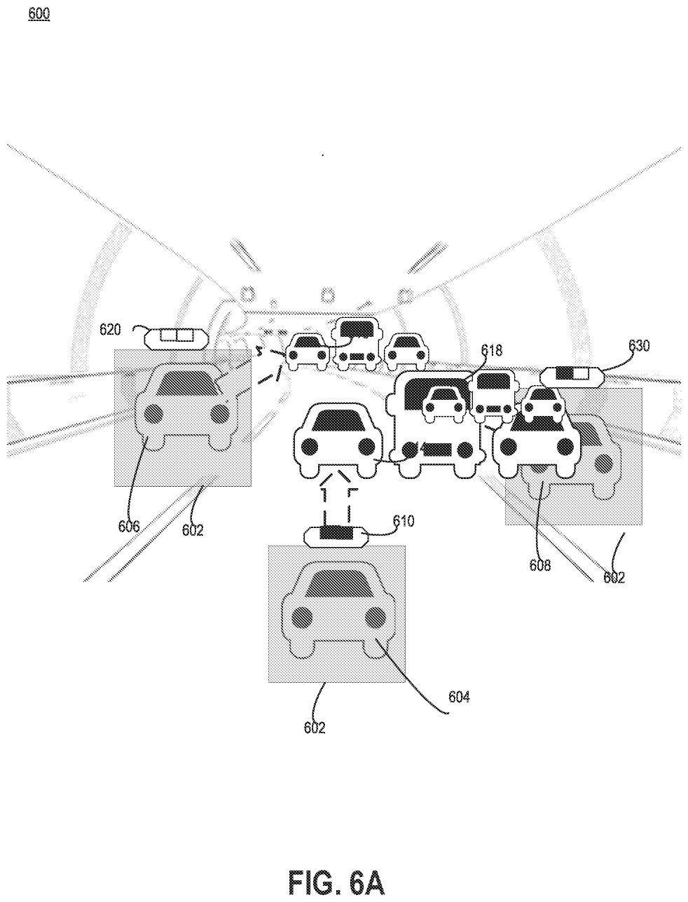

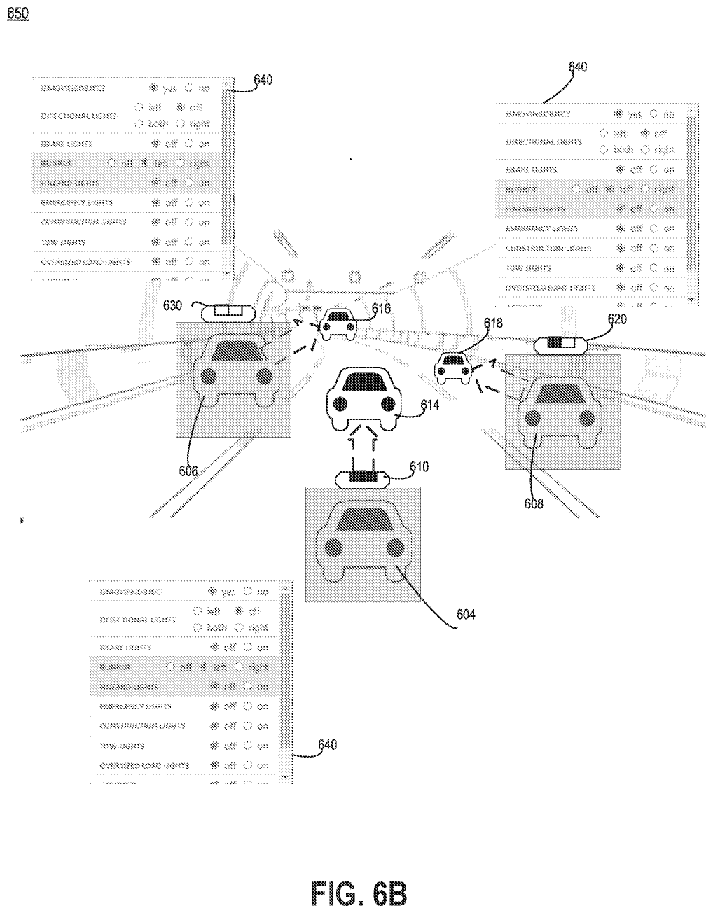

FIGS. 6A-6B illustrate an example of verification of a machine learning model in identifying a light indicator of one or more surrounding vehicles. The verification can be based on comparing the identified light indicator of vehicles in the captured image using the machine learning model and an actual light indicator and the vehicle's driving path. In some embodiments, one or more vehicles in the captured image are verified as having a disagreement between the identified light indicator and the vehicles' actual light indicator and driving path. In these embodiments, the disagreement can be corrected by receiving one or more inputs from an analyst who has the authorization to verify the machine learning model. For ease of illustration, the FIGS. 6A-6B may be discussed with reference to certain components of FIGS. 1, 2, 3A, and 3B.

FIG. 6A illustrates an example of the identified light indicator verification of vehicles in the captured image 600. In some embodiments, the identified light indicator based on the machine learning model can be verified by analyzing a set of sequentially captured images. For example, to verify an identified light indicator of a vehicle in an image, 300 images (10 seconds playing in a video clip with 30 fps) that are immediately captured after the image may be analyzed to determine an actual light indicator and the driving path of the vehicle. The number of images (or video clip playing time) can be determined based on a specific application.

Further in FIG. 6A, for illustration purposes, two captured images are overlayed and used to determine the actual light indicator and driving path of a vehicle included in an image. For example, the first captured image includes a first group of vehicles 604, 606, 608, and the second captured image includes a second group of vehicles 614, 616, 620. The first and second captured images are sequentially captured, whereas the second captured image is captured immediately after the first captured image. In some embodiments, the identified light indicators 610, 620, 630 of vehicles 604, 606, 608 are overlayed on top of the graphical indicia 602 associated with each vehicle. In these embodiments, the light indicator of vehicles 604, 606, 608 are identified using the machine learning model 124. The identified light indicator of the vehicles 604, 606, 608 can be compared with a captured image, including an actual light indicator.

In some embodiments, the actual light indicator can be determined by analyzing the driving path of the vehicles 604, 606, 608. For example, the vehicle 614 included in the second captured image shows that the vehicle 604, identified as “breaking light on,” moved in a forward direction without reducing its speed. In this example, the vehicle 604 can be verified as having a disagreement between the identified signal indicator 610 and the actual signal indicator and driving path 614 of the vehicle. In another example, the vehicle 616 included in the second captured image may verify that the vehicle 606, identified as “light indicator off,” steered into the right lane 616 with a “blinking right turn signal.” In this example, the vehicle 606 is determined as having a disagreement between the identified signal indicator 620 and the actual signal indicator and driving path 616 of the vehicle. Finally, in another example, the vehicle 608, identified as “blinking left turn signal,” moved in forward direction 618 without the “blinking left turn signal.” In this example, the vehicle 608 is determined as having a disagreement between the identified signal indicator 630 and the actual signal indicator and driving path 618 of the vehicle. Various types of disagreements can be detected in the system, and various examples of the disagreement are described above in Table I.

FIG. 6B illustrates an example of an interactive graphical user interface 650 to label the graphical indicia of vehicles in the captured image. For example, an analyst, using the verification computing device 130 may access the interface 640 to correct the light indicator of the vehicles 604, 606, 608 having light indicator 610, 620, 630 that were improperly identified by the machine learning model. The interactive graphical user interface may be provided as an application stored and executed by the verification computing device's processor. In another example, the interactive graphical user interface may be provided by one or more processors, implemented in the network server 128, so the user can correct the light indicator detection of the vehicles using the network server resources. In some embodiments, the interface 604 displays whether each of the vehicle lights are active or inactive. In some embodiments, the user, who is authorized to label or modify the label associated with the vehicle lights, can modify the active or inactive status by utilizing a user input interface, such as a mouse, keyboard, etc.

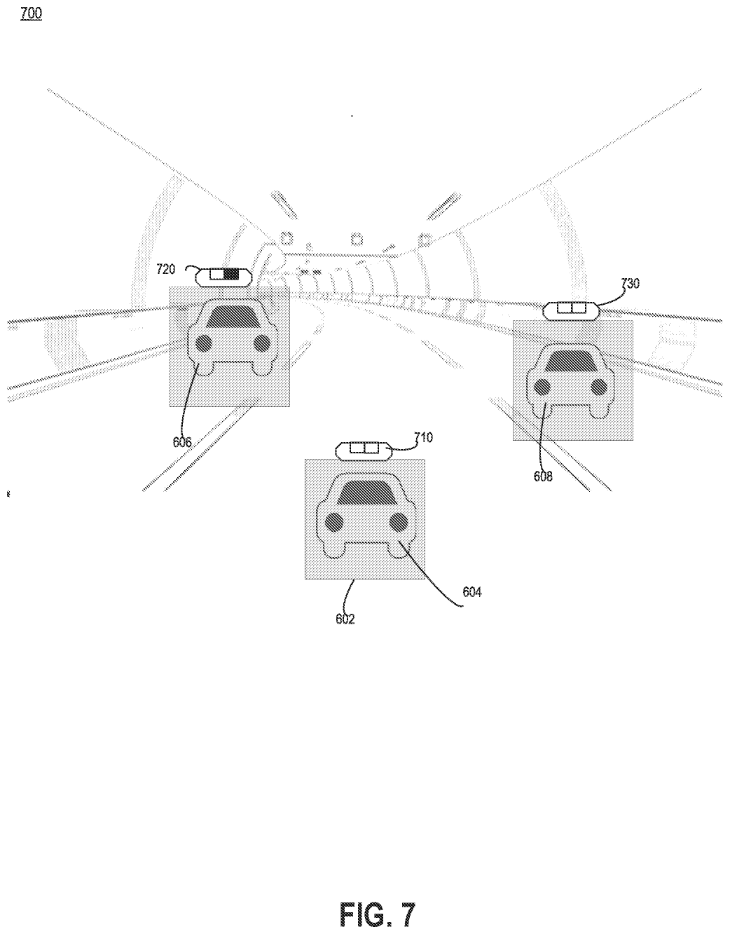

FIG. 7 illustrates an example of labeling the graphical indicia with a correct light indicator of the vehicles in the captured image 700. As shown in FIG. 7, the light indicators of the vehicles 604, 606, 608 (as shown in FIG. 6A) are corrected with the light indicators 710, 720, 730, respectively. For example, the light indicators 610, 620, 630 (as shown in FIG. 6A) are corrected by overlaying the light indicators 710, 720, 730. In some embodiments, the corrected image with the overlayed light indicator labeling is fed into the machine learning model to train the model. In some embodiments, the trained machine learning model can be fed into the autonomous driving system 210 (as shown in FIG. 2).

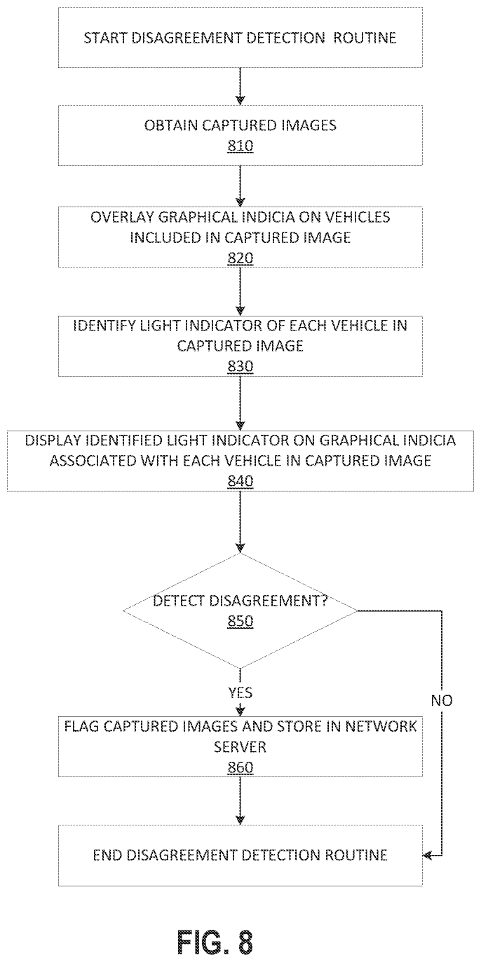

FIG. 8 is a flowchart illustrating one embodiment of an example process that the verification computing device may perform to detect one or more vehicles in a captured image having a disagreement between the identified light indicator and an actual light indicator of the vehicle. Depending on the embodiment, the process illustrated in FIG. 8 may include fewer or additional blocks and/or the blocks may be performed in an order different than is illustrated. For ease of illustration, the process of FIG. 8 may be discussed with reference to certain components of FIGS. 1, 2, 3B, 4, and 5.

Beginning at block 810, the verification computing device may obtain captured images of the surrounding view of a vehicle. The verification computing device may access the captured images by accessing the network server. In some embodiment, the verification computing device downloads the captured images. In other embodiments, the verification computing device may access the captured image using a virtual computing service resources provided by the machine learning training system. In some embodiments, the vehicle may capture front view images of the vehicle using front cameras mounted on the front side of the vehicle, such as on the windshield. The captured images can be in the form of multiple video clips by merging a set of sequentially captured images. For example, every 300 sequentially captured images are merged as a video file that can play for about 10 seconds with 30 fps. The number of captured images and video clip specifications, including frame rate and resolution, can be determined based on a specific application. In some embodiments, the vehicle is configured to wirelessly connect with a network and transmit the captured images to a network server via the network. In some embodiments, the wireless standard to connect to the network is based on such as over a high-speed 4G LTE or other wireless communication technology, such as 5G communications. Thus, in some embodiments, the network may include one or more wireless networks, such as a Global System for Mobile Communications (GSM) network, a Code Division Multiple Access (CDMA) network, a Long Term Evolution (LTE) network, or any other type of wireless network. The network can use protocols and components for communicating via the Internet or any of the other aforementioned types of networks. For example, the protocols used by the network may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

Moving to block 820, the verification computing device may generate a graphical indicia for each of the vehicles and overlay the graphical indicia on each associated vehicle. The graphical indicia can be a box shape and overlayed on top of the vehicles in the captured images. In one embodiment, the verification computing device overlays the graphical indicia on selected vehicles in the captured image, such as a certain number of vehicles closer to the vehicle capturing the images. The number of the selected vehicle can be determined based on a specific application. In some embodiments, the graphical indicia represent one or more semantics associated with the vehicle.

In some embodiments, the graphical representation of the indicia is two-dimensional. In these embodiments, the verification computing device may identify image pixels related to the vehicles. Then, a two-dimensional box (e.g., bounding box) can be generated and overlayed on the image of vehicles. In some embodiments, the verification computing device can perform image segmentation on the captured images to identify the vehicles and any lights. For example, the verification computing device may segment the captured image into regions (e.g., groups of pixels) associated with vehicles and those regions that do not correspond to vehicles. In some embodiments, the verification computing device generates the two-dimensional box (e.g., bounding box) on the regions associated with vehicles. In some embodiments, upon determining the regions associated with vehicles, the graphical indicia overlaying component 338 may generate three-dimensional volume and overlay onto the regions associated with vehicles.

Moving to block 830, in some embodiments, the machine learning model identifies the light indicator of vehicles in the captured images. The identified light indicator can be fed into the verification computing device.

Moving to block 840, the verification computing device may display the identified light indicator associated with each vehicle on graphical indicia of the vehicles in the captured images. For example, the graphical indicia may represent whether the machine learning model identifies the light indicator of the vehicle or not. In some embodiments, the graphical indicia may represent the type of light indicator identified by the machine learning model.

Moving to block 850, the verification computing device may detect a disagreement between the identified light indicator of the vehicle and an actual light indicator of the vehicle. The disagreement can be detected by analyzing a set of sequentially captured images. For example, to verify an identified light indicator of a vehicle in an image, 300 images (10 seconds playing in a video clip with 30 fps) that are immediately captured after the image may be analyzed to determine an actual light indicator and the driving path of the vehicle. The number of images (or video clip playing time) can be determined based on a specific application. In some embodiments, the disagreement type is a false positive or false negative. However, various types of disagreements can be detected in the system, and various examples of the disagreement are described in the above Table I.

Moving to block 860, in determining, at block 850, that one or more vehicles in a captured image are detected as having a disagreement between the identified light indicator and the actual light indicator, the verification computing device may flag the images and store in the network server. The verification computing device also may store the flagged images to its internal or external storage medium. In some embodiments, the stored flag images, including the disagreement, are used to train the machine learning model.

In determining, at block 850, that there is no disagreement, the verification computing device may end the process of detecting the disagreement.

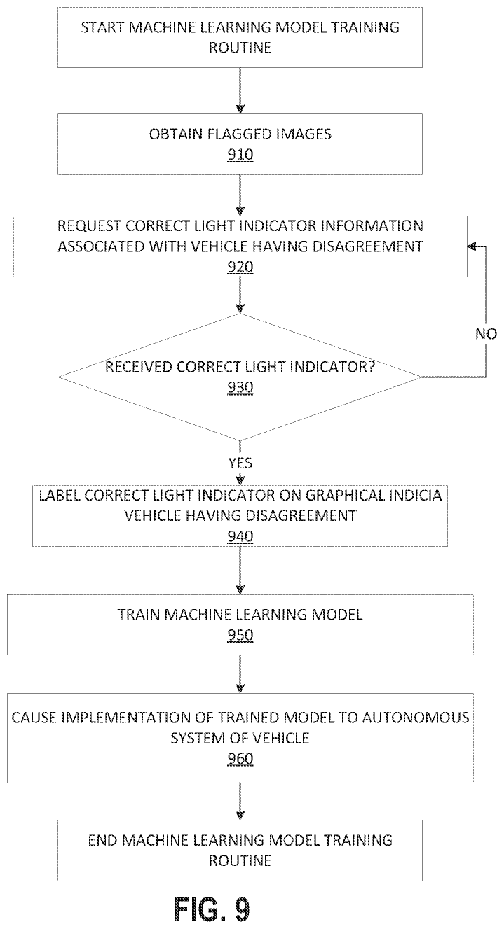

FIG. 9 is a flowchart illustrating one embodiment of an example process that the verification computing device may perform to train the machine learning model. Depending on the embodiment, the process illustrated in FIG. 9 may include fewer or additional blocks and/or the blocks may be performed in an order different than is illustrated. For ease of illustration, the process of FIG. 9 may be discussed with reference to certain components of FIGS. 1, 2, 3A, 3B, and 6A.

Beginning at block 910, the verification computing device may obtain the flagged images by accessing the network server. Each of the flagged images or video clips including the flagged image may include one or more vehicles having a disagreement between identified light indicator and an actual light indicator. In some embodiments, the disagreement type is a false positive or false negative.

Moving to block 920, the verification computing device may request an analyst to correct the light indicator of the vehicles having the disagreement. The analyst can be an authorized user who has the authority to verify the machine learning model, including a manager, developer, supervisor, administrator, etc.

Moving to block 930, the analyst, after receiving the request, may correct the light indicator of vehicles having the disagreement. Moving to block 940, in some embodiments, the analyst may label the graphical indicia of the vehicles having the disagreement. The labeling may include a correct light indicator of the vehicles. In some embodiments, the labeled image with the correct light indicator is overlayed onto the original image with the vehicles having the disagreement. The labeled images may be stored in the network server.

Moving to block 950, the verification computing device may transmit the images, including the label of the correct light indicator of the vehicles to the machine learning model. In these embodiments, the machine learning model receives the labeled image with the correct light indicator and trains the machine learning module. For example, parameters of the machine learning model may be updated (e.g., via gradient descent).

Moving to block 960, in some embodiments, the trained machine learning model can be fed into the autonomous driving system of vehicles. The vehicles may access to the network and download the trained machine learning model via the network.

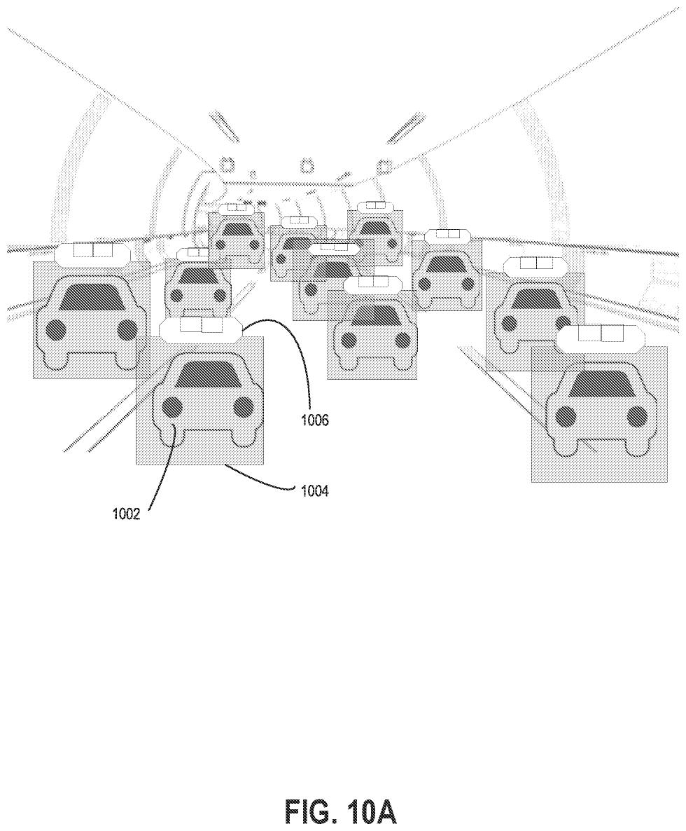

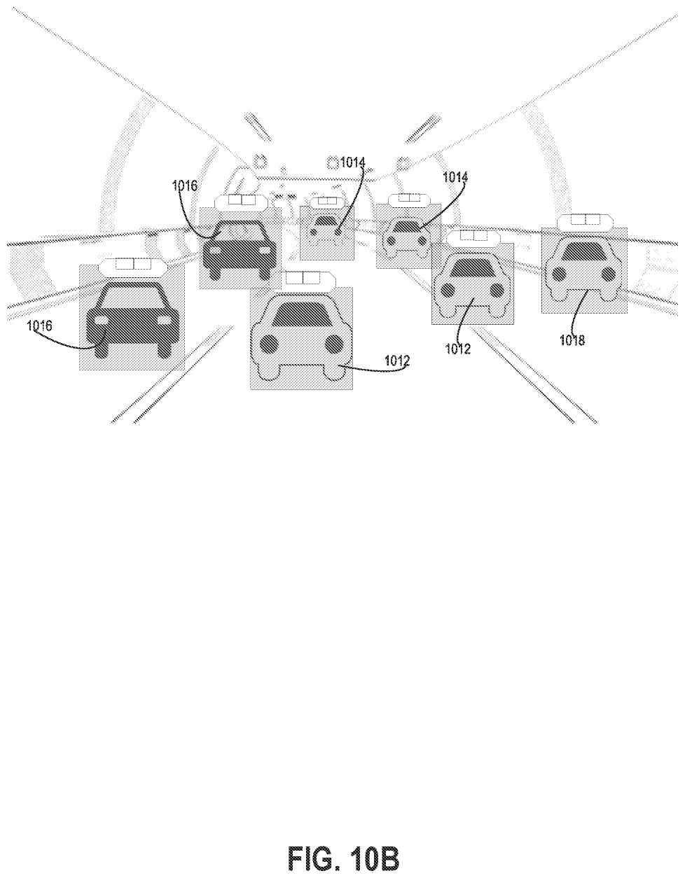

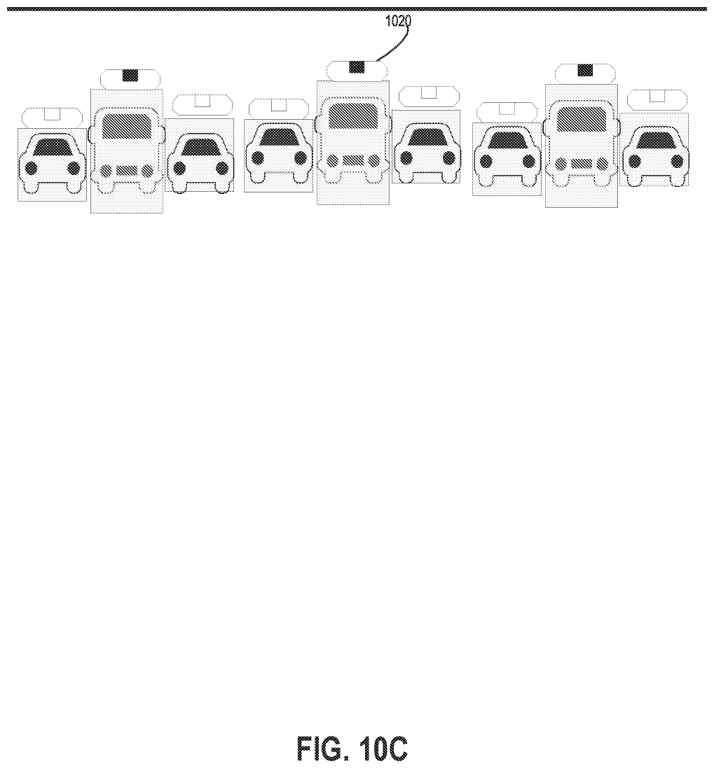

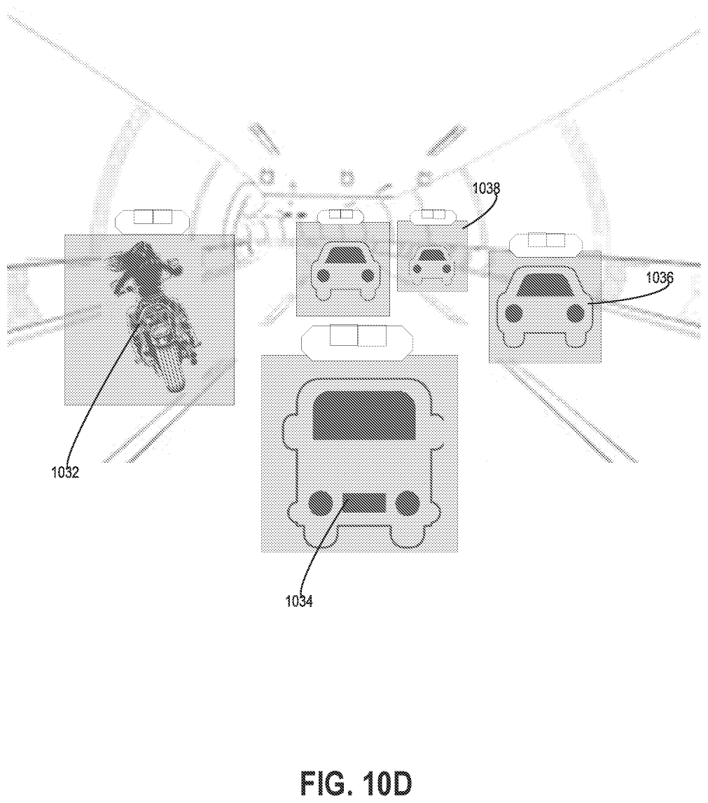

FIGS. 10A-10D illustrate examples of light indicator detection in various environments. The example user interfaces are provided for illustrative purposes to show various functionalities of the system. As mentioned above, the surrounding image of the vehicle is captured using cameras mounted on the vehicle. The autonomous driving system can determine the light indicator by utilizing a machine learning model and displaying it on the detected vehicles included in the captured image.

FIG. TOA is an example of light indicator detection on the high-density road. In a high-density road environment, the vehicle may detect most nearby vehicles and determine the light indicator of detected vehicles positioned closer to the vehicle. For example, the vehicle 110 may determine the light indicator of the closer vehicles 1002.

FIG. 10B is an example of light indicator detection based on priority in determining the light indicator of vehicles. In some embodiments, the analyst may prioritize determining the light indicator of vehicles. For example, the light indicator determination prioritization is based on: the closes vehicles 1012 (e.g., the highest priority); flowing traffic vehicles 1014; oncoming vehicles 1016; and parked vehicles 1018. The prioritization discussed herein are merely examples, and the prioritization is not limited thereto.

FIG. 10C is an example of light indicator detection in a parking lot. As shown in the example, the vehicle may capture images of parking lots and determine a light indicator of a parking lot's vehicle, 1020.

FIG. 10D is an example of light indicator detection for various types of moving objects. As shown in FIG. 10D, the analyst may determine a light indicator of various types of moving objects, including but not limited to motorcycle 1032, bus 1034, and any type of vehicle 1036. In some embodiment, the analyst may determine a light indicator by detecting light in the edge of the vehicle 1038.

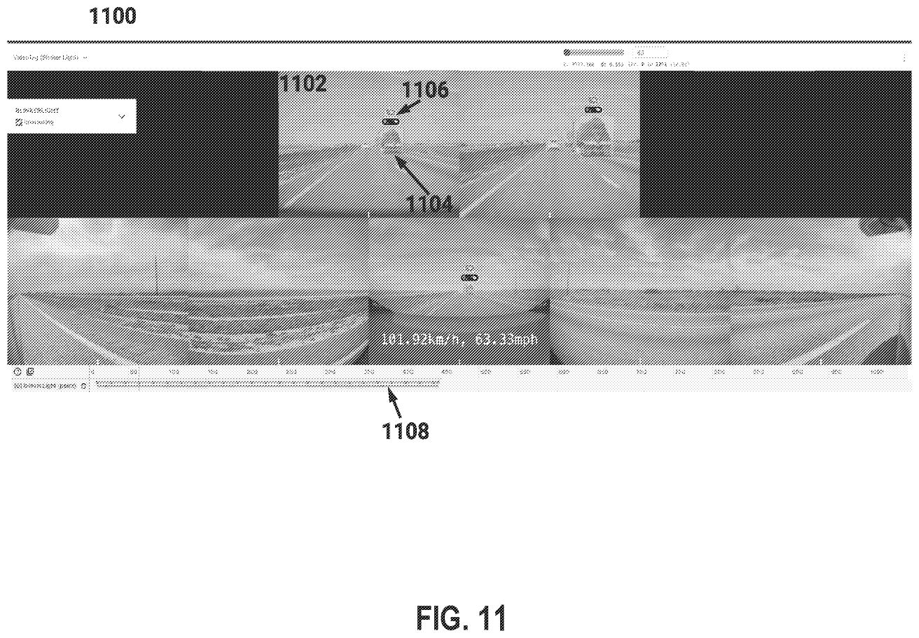

FIG. 11 illustrates an example interactive user interface 1100 which may be used by a user (e.g., an analyst). The interactive user interface 1100 is presenting images from image sensors or cameras positioned about a vehicle. The vehicle, as described herein, may provide images or video clips to a system to update a machine learning model. In the illustrated example, the images thus reflect images from these cameras or image sensors. While images are illustrated, as may be appreciated the images may form a video clip and the user may cause the video clip, or a selected portion thereof, to play.

The user interface 1100 includes a first image 1102 which has a bounding box 1104 about an object (e.g., a truck). As illustrated, the object is included in multiple images from different cameras. Positioned proximate to the bounding box 1104 is alight indicator 1106 (e.g., a graphical indicia of a light indicator), which in this example is a graphical icon (e.g., a hand pointing to the left representing a left blinker). There may be a multitude of graphical icons which provide an easy-short hand way for the user to understand whether the light indicator 1106 is a left blinker, a right blinker, hazard lights, brake lights, and so on.

As described herein, the light indicator 1106 may be determined by the machine learning model executing on the vehicle. For example, and with reference to FIGS. 1-10D, label information may be provided along with the images or video clips indicating, at least, labels associated with lights on vehicles. As another example, the system (e.g., which is presenting the user interface or which analyzes the images or video clips and performs training) may execute the machine learning model to determine the labels.

The light indicator 1106 may be presented proximate to the bounding box 1104 during presentation of a video clip. For example, the light indicator 1106 may be presented at a similar offset from the bounding box 1104 such that it sticks with the bounding box 1104. Similarly, if the object has a trailer attached, the light indicator 1106 may be presented at a similar offset from the trailer.

The user of the user interface 1102 may provide user input to update the light indicator 1106. For example, the user may select the indicator 1106 and be presented with a drop-down menu, or other user interface (e.g., as in FIG. 6B), to update the indicator 1106. In this way, the user may generate ground truth (e.g., the updated indicator 1106) for use in training the machine learning model.

User interface 1100 further includes a progress bar 1108 which enables selection of different portions of a video clip. For example, the progress bar 1108 may extend from a first-time stamp to a final-time stamp. In some embodiments, a portion of the progress bar 1108 may be a first color (e.g., green) which indicates no errors or problems associated with a light indicator. The progress bar 1108 may be a second color (e.g., red) which indicates that a light indicator was updated by the user.

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

As described above, in various embodiments certain functionality may be accessible by a user through a web-based viewer (such as a web browser), or other suitable software program. In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments may not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated the appended claims rather than by the foregoing description. All changes which come within the meaning and range of equivalency of the claims are to be embraced within their scope.

What is claimed is:

1. A system for labeling images for training a machine learning model to detect light indicators on a vehicle, the system including one or more processors and non-transitory computer storage media storing instructions that when executed by the one or more processors cause the one or more processors to perform operations comprising:
obtaining images of one or more vehicles on a roadway;
identifying a position of each of the one or more vehicles;
displaying, via a user interface, a graphical indicia on each of the one or more vehicles to indicate that the vehicle was detected by the system; and
receiving, via the user interface, an indication of whether a light indicator is active or inactive on each of the one or more vehicles to label the image for a machine learning model.

2. The system of claim 1, wherein obtaining images comprises obtaining images from a plurality of vehicles having autonomous driving systems.

3. The system of claim 2, wherein obtaining images comprises obtaining images of the plurality of vehicles when the autonomous driving system determines that a light indicator detection was improperly determined by the autonomous driving system.

4. The system of claim 1, wherein identifying the position of each of the one or more vehicles comprises identifying vehicles in the images and determining graphical coordinates of the vehicles in the images.

5. The system of claim 1, wherein displaying the graphical indicia on each of the one or more vehicles comprising displaying a bounding box around each of the one or more vehicles in the obtained images.

6. The system of claim 1, wherein identifying the position of each of the one or more vehicles comprises performing image segmentation on the obtained images, and wherein the image segmentation generates regions of each obtained images corresponding to the vehicles.

7. The system of claim 1, wherein receiving an indication of whether a light indicator is active or inactive comprises receiving a mouse selection from a user which labels the vehicle as having an active or inactive light indicator.

8. The system of claim 1, wherein receiving the indication of whether a light indicator is active or inactive comprises receiving an indication of whether a brake light is active or inactive.

9. The system of claim 1, wherein receiving the indication of whether a light indicator is active or inactive comprises receiving an indication of whether a turn signal is active or inactive.

10. A system for labeling images for training a machine learning model to detect light indicators on a vehicle, the system including one or more processors and non-transitory computer storage media storing instructions that when executed by the one or more processors cause the one or more processors to perform operations comprising:
obtaining images of one or more vehicles on a roadway;
identifying a position of each of the one or more vehicles in the obtained images;
determining whether a light indicator was indicated as active or inactive by an autonomous driving system in each of the one or more vehicles;
determining, from the images of one or more vehicles, one or more vehicles having a false prediction of whether the light indicator was active or inactive; and
labeling, via a user interface, the images having a false prediction with a correct indication of whether the light indicator is active or inactive.

11. The system of claim 10, wherein identifying the position of each of the one or more vehicles comprises identifying vehicles in the images and determining graphical coordinates of the vehicles in the images.

12. The system of claim 10, wherein obtaining images comprises obtaining images from a plurality of vehicles having autonomous driving systems.

13. The system of claim 12, wherein obtaining images comprises obtaining images from the plurality of vehicles when the autonomous driving system determines that the light indicator detection was improperly determined by the autonomous driving system.

14. The system of claim 10 further comprising displaying, via the user interface, a graphical indicia on each of the one or more vehicles to indicate that the vehicle was detected by the system;

15. The system of claim 14, wherein displaying the graphical indicia on each of the one or more vehicles comprising displaying a bounding box around each of the one or more vehicles in the obtained images.

16. The system of claim 10, wherein the indication of whether the light indicator is active or inactive of each of the one or more vehicles is predicted by an autonomous driving system of each of the vehicles.

17. The system of claim 10, wherein the false prediction is a disagreement between the light indicator and the position of the vehicle.

18. The system of claim 10 further comprising receiving a updated light indicator receiving a mouse selection from a user which labels the vehicle with the light indicator based on the position of the vehicle.

19. The system of claim 10, wherein the indication of whether a light indicator is active or inactive is an indication of whether a brake light is active or inactive.

20. The system of claim 10, wherein the indication of whether a light indicator is active or inactive is an indication of whether a turn signal is active or inactive.

21. A method for labeling images for training a machine learning model to detect light indicators on a vehicle, the method comprising:
obtaining images of one or more vehicles on a roadway;
identifying a position of each of the one or more vehicles;
labeling, via a user interface, an indication of whether a light indicator is active or inactive on each of the one or more vehicles;
determining, from the images of one or more vehicles, one or more vehicles having a false prediction; and
receiving an updated indication of whether the light indicator is active or inactive on the vehicles having the false prediction.

22. The method of claim 21, wherein identifying the position of each of the one or more vehicles comprises identifying vehicles in the images and determining graphical coordinates of the vehicles in the images.

23. The method of claim 21, wherein obtaining images comprises obtaining images from a plurality of vehicles having autonomous driving systems.

24. The method of claim 21, wherein obtaining images comprises obtaining images from the one or more vehicles when the light indicator detection was improperly determined by an autonomous driving system of each vehicle.

25. The method of claim 21 further comprising displaying a graphical indicia on each of the one or more vehicles to indicate that the vehicle was detected by the machine learning model.

26. The method of claim 25, wherein displaying the graphical indicia on each of the one or more vehicles comprising displaying a bounding box around each of the one or more vehicles in the obtained images.

27. The method of claim 21, wherein the indication of whether the light indicator is active or inactive of each of the one or more vehicles is predicted by an autonomous driving system of each of the vehicles.

28. The method of claim 21, wherein the false prediction is a disagreement between the light indicator and the position of the vehicle.

29. The method of claim 21, wherein receiving the updated light indicator comprises receiving a mouse selection from a user which labels the vehicle with the light indicator based on the position of the vehicle.
